(19) United States
(12) Patent Application Publication
(10) Pub. No.: US 2026/0017722 A1
(43) Pub. Date: Jan. 15, 2026

(54) SYSTEMS AND METHODS FOR NON-FUNGIBLE TOKEN ASSET PROTECTION

(71) Applicant: Allstate India Private Limited, Bangalore (IN)

(72) Inventors: Prajakta Joshi, Pimple Gurav (IN); Kare Venkataramana, Bangalore (IN); Shivakant Dubey, Karnataka (IN)

(21) Appl. No.: 18/769,495

(22) Filed: Jul. 11, 2024

(51) Int. Cl. G06Q 40/08; G06F 21/10; G06Q 30/0201

(52) U.S. Cl. CPC G06Q 40/08; G06F 21/1014; G06Q 30/0206

(57) ABSTRACT

Systems and methods for non-fungible token (NFT) asset protection via policy monitoring tool include predicting a prediction that a hack attempt of an NFT asset of a user of the policy monitoring tool has occurred, receiving based on the prediction an insurance claim for processing, validating the insurance claims, determining market price for the NFT asset in real-time based on one or more monitored NFT marketplaces, setting an insurance rate for the NFT asset based on the market price, and transmitting the insurance rate to a graphical user interface (GUI) of a computing device of the user.

### TECHNICAL FIELD

The present disclosure relates to systems and methods for asset protection and, in particular, systems and methods for non-fungible token (NFT) asset protection based on a policy and using a policy monitoring tool such as an artificial intelligence (AI) based software application.

### BACKGROUND

NFTs are blockchain-based tokens that each represent a unique asset, whether physical, digital, or metaphysical. As such, NFTs cannot be exchanged or traded equivalently, unlike other cryptographic assets. NFTs are used to establish ownership and create scarcity, assigning value to the unique asset being represented. While the advent of NFTs has made buying and selling digital art, for example, a reality, NFTs used to represent digital art are not immune to the myriad of techniques used by hackers to pilfer blockchain assets. For example, may NFTs created can become unrecoverable due to private keys being lost and/or stolen by hackers. Accordingly, a need exists for an improved risk management system to manage custody of digital assets and/or private keys.

### BRIEF SUMMARY

According to the subject matter of the present disclosure, a system for non-fungible token (NFT) asset protection may include a policy monitoring tool; one or more processors; one or more memory components communicatively coupled to the one or more processors and the policy monitoring tool; and machine readable instructions stored in the one or more memory components. The policy monitoring tool may include a hack attempt model, a claim validation model, and a market price setting model. The machine readable instructions may cause the system to perform at least the following when executed by the one or more processors: predict, via the hack attempt model, a prediction that a hack attempt of an NFT asset of a user of the policy monitoring tool has occurred, upon receiving the prediction that the hack attempt has occurred, receive an insurance claim for processing, and validate, via a claim validation model, the insurance claim. The machine readable instructions may further cause the system to: determine, via the market price setting model, a market price for the NET asset in real-time based on one or more monitored NFT marketplaces, set an insurance rate for the NET asset based on the market price, and set an insurance rate for the NET asset based on the market price.

According to another embodiment of the present disclosure, a system for NFT asset protection may include may include a policy monitoring tool including a hack attempt model, a claim validation model, and a market price setting model; one or more processors; one or more memory components communicatively coupled to the one or more processors and the policy monitoring tool; and machine readable instructions stored in the one or more memory components. The machine readable instructions may cause the system to perform at least the following when executed by the one or more processors: monitor an NFT asset of the user of the policy monitoring tool, predict, via the hack attempt model, a prediction that a hack attempt of the NFT asset of the user of the policy monitoring tool has occurred, upon receiving the prediction that the hack attempt has occurred, receive an insurance claim for processing, and validate, via a claim validation model, the insurance claim. The user has registered the asset with the policy monitoring tool, and the policy monitoring tool has stored a digital footprint of the user, and user credentials associated with the NET asset are received upon registration of the asset by the user. The machine readable instructions may further cause the system to: determine, via the market price setting model, a market price for the NFT asset in real-time based on one or more monitored NFT marketplaces, set an insurance rate for the NET asset based on the market price and the digital footprint of the user, transmit, via the policy monitoring tool, the insurance rate to a GUI of a computing device of the user, and process a payout of the insurance claim based on the insurance rate to the user.

According to yet another embodiment of the present disclosure, a method for NFT asset protection may include predicting, via a hack attempt model of the policy monitoring tool, a prediction that a hack attempt of an NFT asset of a user of the policy monitoring tool has occurred, upon receiving the prediction that the hack attempt has occurred, receiving an insurance claim for processing, and validating, via a claim validation model of the policy monitoring tool, the insurance claim. The method may further include determining, via a market price setting model of the policy monitoring tool, a market price for the NFT asset in real-time based on one or more monitored NFT marketplaces, setting an insurance rate for the NFT asset based on the market price, and transmitting, via the policy monitoring tool, the insurance rate to a GUI of a computing device of the user.

Although the concepts of the present disclosure are described herein with primary reference to a system for NFT asset protection based on an insurance policy, it is contemplated that the concepts will enjoy applicability to any setting for purposes of asset protection of various types of cryptocurrency and not limited to insurance policies.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates an environment for an NFT asset protection solution including a policy monitoring tool, according to one or more embodiments shown and described herein;

FIG. 2 illustrates a flowchart process for use with the environment of FIG. 1 to implement the NFT asset protection solution using the policy monitoring tool, according to one or more embodiments shown and described herein;

FIG. 3 illustrates a logic of a control scheme associated with a hack attempt model and a claim validation model of the policy monitoring tool of FIG. 1 to implement the process of FIG. 2, according to one or more embodiments shown and described herein;

FIG. 4 illustrates a logic of a control scheme associated with a market price setting model of the policy monitoring tool of FIG. 1 to implement the process of FIG. 2, according to one or more embodiments shown and described herein;

FIG. 5 illustrates a computer implemented system including a system for use with the process flow of FIG. 2 and NFT asset protection solution via the environment of FIG. 1, according to one or more embodiments shown and described herein.

### DETAILED DESCRIPTION

In embodiments described herein, systems and methods used to protect owners of digital assets and/or NFTs from financial losses incurred as a result of successful hacking attempts. Embodiments of the present disclosure describe systems and methods for NFT asset protection include a comprehensive form of insurance coverage for a registered NFT asset designed around risks inherent in NFTs.

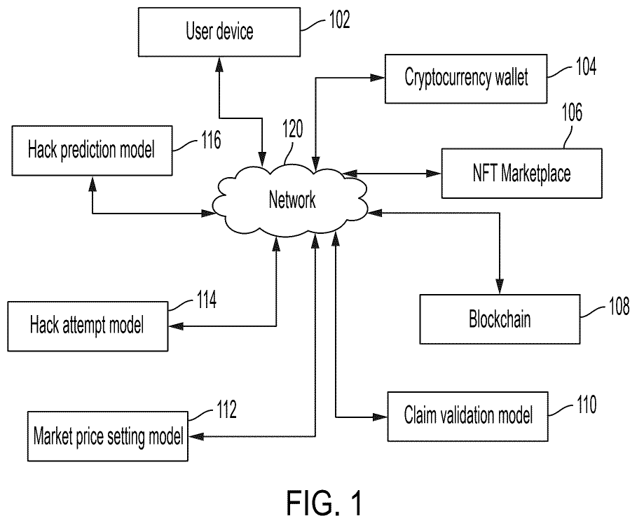

In embodiments, the system includes a machine learning (ML) model (referred to herein as the hack prediction model 116, described in FIG. 1 below) trained to (1) predict the risk of a hacker gaining unauthorized access to an owner's private key, NFT, and/or digital asset and/or an ML model (referred to as a hack attempt model 114, described in FIG. 1 below) (2) predict the detection of a hack attempt to the owner's private key, NFT, and/or digital asset. Model input data used by the hack prediction model to make one or both of these predictions may include at least blockchain transaction data and/or a digital footprint specific to the owner being insured (e.g., use of the policy monitoring tool 120 of FIG. 1 described herein). In certain embodiments, hack attempt predictions returned by the model(s) may be subsequently validated (by a claim validation model 110 of FIG. 1) to determine whether a hack did indeed occur, and whether this hack was successful. Successful hack attempts validated by the system may be used to generate at least one insurance claim.

For example, in embodiments, the system may include another ML model referred to herein as an “incident analysis model” as part of the claim validation model 110. The incident analysis model may be triggered when an insurance claim is created to inspect and judge the merit of the claim. In particular, the incident analysis model may identify what happened during the hack, and more specifically, discover what parties and/or what assets were involved. The incident analysis model may use this information, and in some cases, information about the owner's current coverage and/or history, to predict whether the claim is valid, and accordingly eligible for payout, or is alternatively fraudulent.

The system may include a third ML model (referred to herein as a market price setting model 112 of FIG. 1) configured to return an estimated market price for an NFT and/or digital asset associated with a validated insurance claim. In certain embodiments, the market price setting model monitors transactions of an NFT on the blockchain and uses this information as input data. In certain embodiments, the market price setting model determines the likelihood of a duplicate copy of the NFT existing in the marketplace and uses this information when estimating the market price of the NFT. An estimated market price returned by the market price setting model may be used to inform and set the compensation price for a validated insurance claim.

Referring to FIG. 1, an environment 100 is depicted for an NFT asset protection solution including a policy monitoring tool 120. The environment 100 includes a user computing device 102, which may be a user mobile device or other computing device with a graphical user interface (GUI). The environment 100 further includes a cryptocurrency wallet 104, at least one NFT marketplace 106, and a blockchain 108. The cryptocurrency wallet 104 may be a digital wall associated with a user include fungible cryptocurrencies and cryptocurrency assets and non-fungible cryptocurrency assets (such as NFTs). As part of the policy monitoring tool 120, the environment includes a claim validation model 110, a market price setting model 112, a hack attempt model 114, and a hack prediction model 116. The policy monitoring tool 120 is communicatively coupled to the components 102-116 of the environment 100 and is able to transmit data to and receive data from the components 102-116 shown.

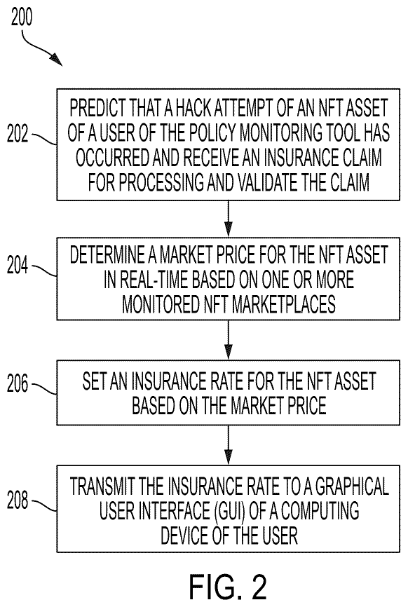

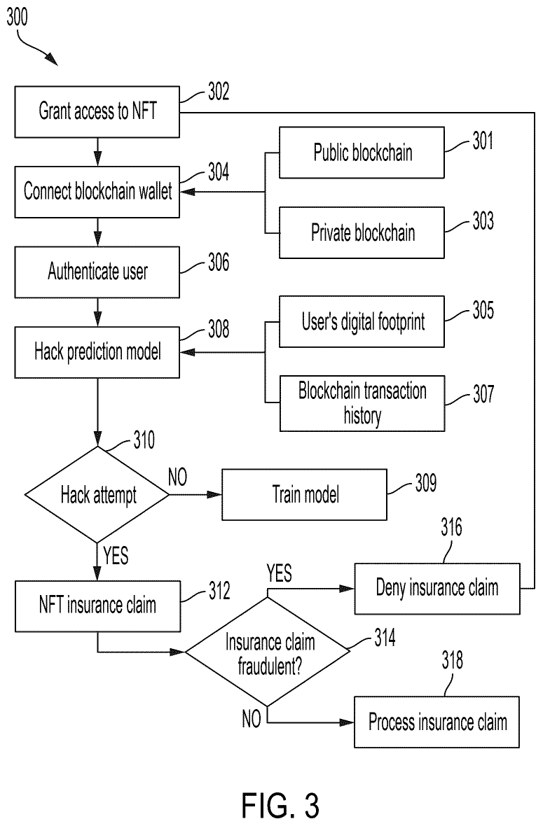

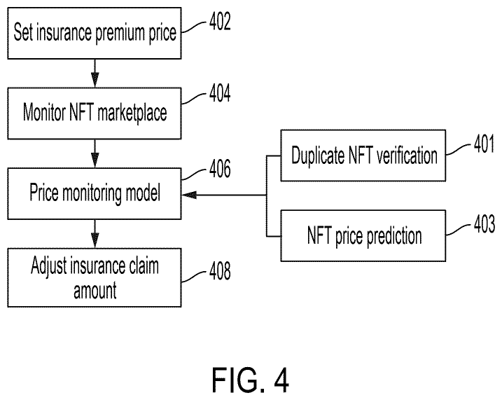

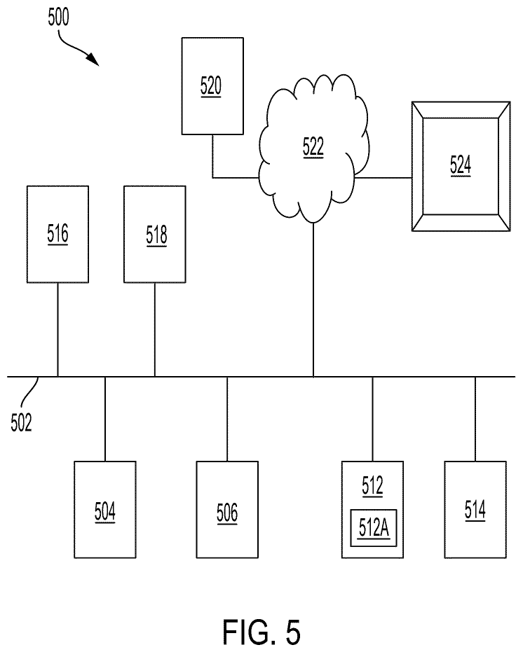

Referring to FIG. 2, an embodiment of a process 200 is shown for use of the intelligent NFT asset protection solution using the policy monitoring tool 120 via the environment 100 of FIG. 1 (as implemented by a system 500 of FIG. 5, described in greater detail below). As will be described in greater detail further below, the system 500 may include machine readable instructions stored in one or more memory components 506 communicatively coupled to one or more processors 504, which instructions cause the system 500 to perform a control scheme as described herein, such as the process 200 of FIG. 2 and/or control schemes 300, 400 of FIGS. 3-4, described in greater detail further below, when executed by the one or more processors 504. The system 500 for NFT asset protection may thus include the policy monitoring tool 120, which includes the claim validation model 110, the market price setting model 112, and the hack attempt model 114, the policy monitoring tool 120 communicatively coupled to the one or more processors 504 and the one or more memory components 506.

In block 202, via the hack attempt model 114, a prediction is predicted that a hack attempt of an NFT asset of a user of the policy monitoring tool 120 has occurred. Upon receiving the prediction that a hack attempt has occurred, and associated insurance claim may be received or triggered for processing. Via the claim validation model 110, the insurance claim may be validated as a non-fraudulent insurance claim.

In embodiments, the NFT asset of the user of the policy monitoring tool 120 may be monitored, the using having registered the NFT asset with the policy monitoring tool 120. Further, the policy monitoring tool 120 may have stored a digital footprint of the user, such as upon registration by the user of the NFT asset. The digital footprint of the user may include usage data associated with the user based on user activities and a risk score based on the usage data (e.g., such as determined by a usage data sub-module 512A of system 500 of FIG. 5, described in greater detail further below).

When the risk score is below an acceptable risk threshold, the insurance rate is increased and thus is indicative of a lower level of risk acceptability than when the risk score is above the acceptable risk threshold. In embodiments, based on the usage data, the user may be determined to have conducted a risk activity that may cause the risk score to drop below the acceptable risk threshold. The risk activity may include visiting one or more blacklisted websites, one or more websites labeled as risky, opening a malicious link (such as within a website or via an email), operating social media accounts is a manner to engage with other defined risky social media accounts or pages, or combinations thereof. The risk score may be increased based on a determination that the user has conducted the risk activity.

In embodiments, a download notification may be received by the policy monitoring tool 120 that the user has downloaded the policy monitoring tool 120 as an application on the computing device 102 of the user. A registration notification may be received that the user has registered the NFT asset with the policy monitoring tool 120. An insurance policy for the NFT asset of the user may be issued by, and stored within, the policy monitoring tool 120 based on the download notification and the registration notification.

In embodiments, user credentials associated with the NET asset of the user may be received upon registration of the NET asset by the user. The user credentials may be a requirement for the user to provide upon registration by the user with respect to the policy monitoring tool 120 as part of acceptance criteria by the policy monitoring tool 120 for the user to be issued a policy for the NFT asset. The user credentials may include private key information to access one or more digital assets to be registered such as the NFT asset such that a backup access via the policy monitoring tool 120 is provided when, for example, a private key may be lost or stolen. The user credentials associated with the NET asset may be stored in a private cloud storage, the private cloud storage communicatively coupled with the policy monitoring tool 120. The user may opt to store the NFT in the private cloud storage associated with the policy monitoring tool 120, and the risk score may be decreased. Alternatively or additionally, the NET asset may be accessed via the policy monitoring tool 120 and based on the user credentials when the NFT asset is stored in a public cloud storage. The access may be triggered based on receipt of input of at least one of access to the NFT asset being lost by the user or stolen. A user opting to retain the NFT asset in the public cloud storage may cause the risk score to be increased.

The hack attempt model 114 may be trained to predict that the hack attempt has occurred based on one or more patterns and risk factors associated with one or more historical hack attempts of one or more NFT assets. Such risk factors may be connected to a risk activity of the user, as descried herein, such as visiting one or more blacklisted websites, one or more websites labeled as risky, opening a malicious link (such as within a website or via an email), operating social media accounts is a manner to engage with other defined risky social media accounts or pages, or combinations thereof. Risk factors may be classified at separate levels, such as a red zone for a risk of a highest level, a yellow zone for a risk of a next medium level under the highest level, and a green zone for an acceptable, low level risk under the medium level. Different risk factors may have different weights, such as, for example, a greater weight being given to a blacklisted website visit than a risky website visit. Cookies associated with a user's usage data and website history may be used to track a user's digital activities for risk monitoring, including, but not limited to, such website visits and/or time spent at certain digital sites and/or transactions made. The NFT asset of the user may be one of the one or more NFT assets. Via the hack attempt model 114 and/or the hack prediction model 116, a likelihood of hack attempt occurring with respect to the NFT asset of the user may be predicted based on the patterns and risk factors associated with the one or more historical hack attempts of the one or more NFT assets and a digital footprint of the user of the NFT asset. Patterns may include and not be limited to, for example, times to access the NFT asset typically not at times a user has attempted access, attempts to access based on incorrect keys and a number of access attempts, a number of access attempts within a time period, a number of access attempts by others not identified and authenticated as the user, a number of access attempts using a plurality of different keys within a time period, and the like. The digital footprint of the user may include usage data associated with the user based on user activities as described herein.

In block 204, via the market price setting model 112, a market price for the NFT asset is determined in real-time based on one or more monitored NFT marketplaces 106 (FIG. 1). As described in greater detail below for control scheme 400, the market price may take into consideration an initial premium price set for the policy and real-time information based on the one or more monitored NFT marketplaces 106 regarding trading and/or purchasing of digital assets as well as risk factors to determine a best forecasted price to set for the NFT asset.

In block 206, an insurance rate is for the NET asset based on the market price determined in block 204. An insurance rate for the NFT asset may be set based on the market price and the digital footprint of the user, which may further take into consideration risk factors of risk activities associated with the user as detected using the digital footprint and described herein. The insurance rate further takes into consideration an initial premium price set for the policy. In situations in which a private key is retrieved and/or a digital asset retrieved or returned, a claim policy may not need to then be processed and the insurance rate as set if determined may replace the current policy price premium.

In block 208, via the policy monitoring tool 120, the insurance rate is transmitted to a GUI of the computing device 102 of the user. In embodiments, the payout of the insurance rate may be processed based on the insurance rate to the user.

Referring to FIG. 3, a control scheme 300 is shown that is associated with the claim validation model 110 and the hack attempt model 114 of the policy monitoring tool 120 of FIG. 1 to implement a portion of the process 200 of FIG. 2. In block 302, the policy monitoring tool 120 is granted access to an NET asset of a user who is registering with the policy monitoring tool 120. The policy monitoring tool 120 connects with a blockchain wallet 304 based on information from at least a public blockchain 301 and a private blockchain 303 to authenticate 306 the user and the NFT asset of the user. In embodiments, the authentication 306 may further include a biometric identification of the user. If another user is attempting to user a private key to access the NFT asset, the authentication 306 may fail indicating an authorized user is attempting to access the NFT asset. In block 308, the hack attempt model 114 and/or hack prediction model 116 input data from a digital footprint of the user as input 305 and/or blockchain transaction history as input 307 (such as of the NET asset) to determine in determination 310 whether a hack attempt has occurred. If not, the data is used to further train the model(s) in block 309. If so, an insurance claim for the NFT asset is created in block 312. Upon a determination 314, such as by the claim validation model 110, that the insurance claim is fraudulent, the insurance claim is denied in block 316. Upon a determination 314 that the insurance claim is not fraudulent, the insurance claim is processed in block 318.

Referring to FIG. 4, a control scheme 400 is shown associated with the market price setting model 112 of the policy monitoring tool 120 of FIG. 1 to implement another portion of the process 200 of FIG. 2. In block 402, an insurance premium policy price is set for the NFT asset upon registration. In block 404, one or more NFT marketplaces and transactions therein are monitored. An example of a monitored NFT marketplace is OPENSEA, in which NFT assets are auctioned and can be bought and/or traded and can use cryptocurrency-based payment methods. In block 406, a price monitoring model of the market price setting model 112 receives as input 401 any duplicate NFT verifications and as input 403 a NFT price prediction. Based on the inputs 401, 403 and monitored marketplaces of block 404, setting an insurance rate, an insurance claim amount from block 318 of FIG. 3 can be adjusted to the set insurance rate.

FIG. 5 illustrates a computer implemented system 500 for use with the process 200 of FIG. 2, control schemes 300, 400 of FIGS. 3-4, and the environment 100 of FIG. 1. Referring to FIG. 3, a non-transitory system 500 is shown for implementing a computer and software-based method, such as directed by the environment 100 and the process 200, as well as control schemes 300, 400, for intelligent NFT asset protection as described herein. The system 500 comprises a communication path 502, one or more processors 504, a non-transitory memory component 506, a policy monitoring tool module 512, a usage data sub-module 512A of the policy monitoring tool module 512, a storage or database 514, a machine learning module 516, a network interface hardware 518, a network 522, a server 520, and a computing device 524 communicatively coupled to one or more GUIs. The various components of the system 500 and the interaction thereof will be described in detail below.

While only one server 520 and one computing device 524 are illustrated, the system 500 can comprise multiple servers containing one or more applications and computing devices. In some embodiments, the system 500 is implemented using a wide area network (WAN) or network 522, such as an intranet or the internet. The computing device 524 may include digital systems and other devices permitting connection to and navigation of the network. It is contemplated and within the scope of this disclosure that the computing device 524 (e.g., the user computing device 102 of FIG. 1) may be a personal computer, a laptop device, a smart mobile device such as a smart phone or smart pad, or the like. Other system 500 variations allowing for communication between various geographically diverse components are possible. The lines depicted in FIG. 5 indicate communication rather than physical connections between the various components.

The system 500 comprises the communication path 502. The communication path 502 may be formed from any medium that is capable of transmitting a signal such as, for example, conductive wires, conductive traces, optical waveguides, or the like, or from a combination of mediums capable of transmitting signals. The communication path 502 communicatively couples the various components of the intelligent system 500. As used herein, the term “communicatively coupled” means that coupled components are capable of exchanging data signals with one another such as, for example, electrical signals via conductive medium, electromagnetic signals via air, optical signals via optical waveguides, and the like.

The intelligent system 500 of FIG. 5 also comprises the processor 504. The processor 504 can be any device capable of executing machine readable instructions. Accordingly, the processor 504 may be a controller, an integrated circuit, a microchip, a computer, or any other computing device. The processor 504 is communicatively coupled to the other components of the system 500 by the communication path 502. Accordingly, the communication path 502 may communicatively couple any number of processors with one another, and allow the modules coupled to the communication path 502 to operate in a distributed computing environment. Specifically, each of the modules can operate as a node that may send and/or receive data.

The illustrated system 500 further comprises the memory component 506, which is coupled to the communication path 502 and communicatively coupled to the processor 504. The memory component 506 may be a non-transitory computer readable medium or non-transitory computer readable memory and may be configured as a nonvolatile computer readable medium. The memory component 506 may comprise RAM, ROM, flash memories, hard drives, or any device capable of storing machine readable instructions such that the machine readable instructions can be accessed and executed by the processor 504. The machine readable instructions may comprise logic or algorithm(s) written in any programming language such as, for example, machine language that may be directly executed by the processor 504, or assembly language, object-oriented programming (OOP), scripting languages, microcode, etc., that may be compiled or assembled into machine readable instructions and stored on the memory component 506. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Still referring to FIG. 5, as noted above, the system 500 comprises the display such as the GUI on a screen of the computing device 524 for providing visual output such as, for example, information, graphical reports, messages, or a combination thereof. The display on the screen of the computing device 524 is coupled to the communication path 502 and communicatively coupled to the processor 504. Accordingly, the communication path 502 communicatively couples the display to other modules of the intelligent system 500. The display can comprise any medium capable of transmitting an optical output such as, for example, a cathode ray tube, light emitting diodes, a liquid crystal display, a plasma display, or the like. Additionally, it is noted that the display or the computing device 524 can comprise at least one of the processor 504 and the memory component 506. While the system 500 is illustrated as a single, integrated system in FIG. 5, in other embodiments, the systems can be independent systems.

The system 500 comprises the policy monitoring tool module 512 as described above for NFT asset protection based on at least usage data of a user of an NFT asset registered with and protected by the policy monitoring tool 120 executed by the policy monitoring tool module 512, which usage data is received and analyzed by the usage data sub-module 512A. The machine learning module 516 communicatively coupled to the policy monitoring tool module 512 and the usage data sub-module 512A may include an artificial intelligence component to train and provide machine learning capabilities to a neural network as described herein for intelligent NFT asset protection.

The policy monitoring tool module 512, the usage data sub-module 512A, and the machine learning module 516 are coupled to the communication path 502 and communicatively coupled to the processor 504. As will be described in further detail below, the processor 504 may process the input signals received from the system modules and/or extract information from such signals.

Data stored and manipulated in the system 500 as described herein is utilized by the machine learning module 516, which is able to leverage a cloud computing-based network configuration such as the cloud to apply Machine Learning and Artificial Intelligence. This machine learning application may create models that can be applied by the system 500, to make it more efficient and intelligent in execution. As an example and not a limitation, the machine learning module 516 may include artificial intelligence components selected from the group consisting of an artificial intelligence engine, Bayesian inference engine, and a decision-making engine, and may have an adaptive learning engine further comprising a deep neural network learning engine.

The system 500 comprises the network interface hardware 518 for communicatively coupling the system 500 with a computer network such as network 522. The network interface hardware 518 is coupled to the communication path 502 such that the communication path 502 communicatively couples the network interface hardware 518 to other modules of the intelligent system 500. The network interface hardware 518 can be any device capable of transmitting and/or receiving data via a wireless network. Accordingly, the network interface hardware 518 can comprise a communication transceiver for sending and/or receiving data according to any wireless communication standard. For example, the network interface hardware 518 can comprise a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

Still referring to FIG. 5, data from various applications running on computing device 524 can be provided from the computing device 524 to the system 500 via the network interface hardware 518. The computing device 524 can be any device having hardware (e.g., chipsets, processors, memory, etc.) for communicatively coupling with the network interface hardware 518 and a network 522. Specifically, the computing device 524 can comprise an input device having an antenna for communicating over one or more of the wireless computer networks described above.

The network 522 can comprise any wired and/or wireless network such as, for example, wide area networks, metropolitan area networks, the internet, an intranet, satellite networks, or the like. Accordingly, the network 522 can be utilized as a wireless access point by the computing device 524 to access one or more servers (e.g., a server 520). The server 520 and any additional servers generally comprise processors, memory, and chipset for delivering resources via the network 522. Resources can include providing, for example, processing, storage, software, and information from the server 520 to the system 500 via the network 522. Additionally, it is noted that the server 520 and any additional servers can share resources with one another over the network 522 such as, for example, via the wired portion of the network, the wireless portion of the network, or combinations thereof.

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is also noted that recitations herein of “at least one” component, element, etc., should not be used to create an inference that the alternative use of the articles “a” or “an” should be limited to a single component, element, etc.

It is noted that recitations herein of a component of the present disclosure being “configured” or “programmed” in a particular way, to embody a particular property, or to function in a particular manner, are structural recitations, as opposed to recitations of intended use.

It is noted that terms like “preferably,” “commonly,” and “typically,” when utilized herein, are not utilized to limit the scope of the claimed disclosure or to imply that certain features are critical, essential, or even important to the structure or function of the claimed disclosure. Rather, these terms are merely intended to identify particular aspects of an embodiment of the present disclosure or to emphasize alternative or additional features that may or may not be utilized in a particular embodiment of the present disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

### Aspects Listing:

Aspect 1. A system for non-fungible token (NFT) asset protection may include a policy monitoring tool; one or more processors; one or more memory components communicatively coupled to the one or more processors and the policy monitoring tool; and machine readable instructions stored in the one or more memory components. The policy monitoring tool may include a hack attempt model, a claim validation model, and a market price setting model. The machine readable instructions may cause the system to perform at least the following when executed by the one or more processors: predict, via the hack attempt model, a prediction that a hack attempt of an NFT asset of a user of the policy monitoring tool has occurred, upon receiving the prediction that the hack attempt has occurred, receive an insurance claim for processing, and validate, via a claim validation model, the insurance claim. The machine readable instructions may further cause the system to: determine, via the market price setting model, a market price for the NFT asset in real-time based on one or more monitored NFT marketplaces, set an insurance rate for the NFT asset based on the market price, and set an insurance rate for the NFT asset based on the market price.

Aspect 2. The system of Aspect 1, further including machine readable instructions that cause the system to perform at least the following when executed by the one or more processors: monitor the NFT asset of the user of the policy monitoring tool, wherein the user has registered the asset with the policy monitoring tool, and the policy monitoring tool has stored a digital footprint of the user.

Aspect 3. The system of Aspect 2, further including machine readable instructions that cause the system to perform at least the following when executed by the one or more processors: set the insurance rate for the NET asset based on the market price and the digital footprint of the user.

Aspect 4. The system of any of Aspect 2 to Aspect 3, wherein the digital footprint of the user comprises usage data associated with the user based on user activities and a risk score based on the usage data, wherein when the risk score is below an acceptable risk threshold, the insurance rate is increased.

Aspect 5. The system of Aspect 4, further including machine readable instructions that cause the system to perform at least the following when executed by the one or more processors: determine, based on the usage data, that the user has conducted a risk activity comprising visiting one or more blacklisted websites, opening a malicious link, or combinations thereof, and decrease the risk score based on the risk activity.

Aspect 6. The system of any of Aspect 1 to Aspect 5, further including machine readable instructions that cause the system to perform at least the following when executed by the one or more processors: receive user credentials associated with the NET asset of the user upon registration of the asset by the user.

Aspect 7. The system of Aspect 6, further including machine readable instructions that cause the system to perform at least the following when executed by the one or more processors: store the user credentials associated with the NFT asset in a private cloud storage, the private cloud storage communicatively coupled with the policy monitoring tool.

Aspect 8. The system of Aspect 6 or Aspect 7, further including machine readable instructions that cause the system to perform at least the following when executed by the one or more processors: access, via the policy monitoring tool and based on the user credentials, the NFT asset when the NFT is stored in public cloud storage based on receipt of input of at least one of access to the NFT asset being lost by the user or stolen.

Aspect 9. The system of any Aspect 1 to Aspect 8, further comprising machine readable instructions that cause the system to perform at least the following when executed by the one or more processors: process a payout of the insurance claim based on the insurance rate to the user.

Aspect 10. The system of any Aspect 1 to Aspect 9, further comprising machine readable instructions that cause the system to perform at least the following when executed by the one or more processors: receive a download notification that the user has downloaded the policy monitoring tool as an application on the computing device of the user, receive a registration notification that the user has registered the NFT asset with the policy monitoring tool, and issue an insurance policy for the NFT asset of the user based on the download notification and the registration notification.

Aspect 11. The system of any of Aspect 1 to Aspect 10, further comprising machine readable instructions that cause the system to perform at least the following when executed by the one or more processors: train the hack attempt model to predict that the hack attempt has occurred based on one or more patterns and risk factors associated with one or more historical hack attempts of one or more NFT assets, wherein the NFT asset of the user may be one of the one or more NFT assets.

Aspect 12. The system of Aspect 11, further comprising machine readable instructions that cause the system to perform at least the following when executed by the one or more processors: predict, via the hack attempt model, a likelihood of hack attempt occurring with respect to the NET asset of the user based on the patterns and risk factors associated with the one or more historical hack attempts of the one or more NFT assets and a digital footprint of the user of the NET asset, wherein the digital footprint of the user comprises usage data associated with the user based on user activities.

Aspect 13. A system for NFT asset protection may include may include a policy monitoring tool including a hack attempt model, a claim validation model, and a market price setting model; one or more processors; one or more memory components communicatively coupled to the one or more processors and the policy monitoring tool; and machine readable instructions stored in the one or more memory components. The machine readable instructions may cause the system to perform at least the following when executed by the one or more processors: monitor an NFT asset of the user of the policy monitoring tool, predict, via the hack attempt model, a prediction that a hack attempt of the NET asset of the user of the policy monitoring tool has occurred, upon receiving the prediction that the hack attempt has occurred, receive an insurance claim for processing, and validate, via a claim validation model, the insurance claim. The user has registered the asset with the policy monitoring tool, and the policy monitoring tool has stored a digital footprint of the user, and user credentials associated with the NFT asset are received upon registration of the asset by the user. The machine readable instructions may further cause the system to: determine, via the market price setting model, a market price for the NFT asset in real-time based on one or more monitored NFT marketplaces, set an insurance rate for the NFT asset based on the market price and the digital footprint of the user, transmit, via the policy monitoring tool, the insurance rate to a GUI of a computing device of the user, and process a payout of the insurance claim based on the insurance rate to the user.

Aspect 14. The system of Aspect 13, wherein the digital footprint of the user comprises usage data associated with the user based on user activities and a risk score based on the usage data, wherein when the risk score is below an acceptable risk threshold, the insurance rate is increased.

Aspect 15. The system of Aspect 14, further comprising machine readable instructions that cause the system to perform at least the following when executed by the one or more processors: determine, based on the usage data, that the user has conducted a risk activity comprising visiting one or more blacklisted website, opening a malicious link, or combinations thereof, and decrease the risk score based on the risk activity.

Aspect 16. The system of any of Aspect 13 or Aspect 15, further comprising machine readable instructions that cause the system to perform at least the following when executed by the one or more processors: store the user credentials associated with the NFT asset in a private cloud storage, the private cloud storage communicatively coupled with the policy monitoring tool.

Aspect 17. The system of any Aspect 1 to Aspect 16, further comprising machine readable instructions that cause the system to perform at least the following when executed by the one or more processors: access, via the policy monitoring tool and based on the user credentials, the NET asset when the NFT is stored in public cloud storage based on receipt of input of at least one of access to the NFT asset being lost by the user or stolen.

Aspect 18. The system of any Aspect 1 to Aspect 17, further comprising machine readable instructions that cause the system to perform at least the following when executed by the one or more processors: train the hack attempt to predict that the hack attempt has occurred based on one or more patterns and risk factors associated with one or more historical hack attempts of one or more NFT assets, wherein the NFT asset of the user may be one of the one or more NFT assets.

Aspect 19. The system of Aspect 18, further including machine readable instructions that cause the system to perform at least the following when executed by the one or more processors: predict, via the hack attempt model, a likelihood of hack attempt occurring with respect to the NFT asset of the user based on the patterns and risk factors associated with the one or more historical hack attempts of the one or more NFT assets and the digital footprint of the user of the NFT asset, wherein the digital footprint of the user comprises usage data associated with the user based on user activities.

Aspect 20. A method for NFT asset protection may include predicting, via a hack attempt model of the policy monitoring tool, a prediction that a hack attempt of an NFT asset of a user of the policy monitoring tool has occurred, upon receiving the prediction that the hack attempt has occurred, receiving an insurance claim for processing, and validating, via a claim validation model of the policy monitoring tool, the insurance claim. The method may further include determining, via a market price setting model of the policy monitoring tool, a market price for the NFT asset in real-time based on one or more monitored NFT marketplaces, setting an insurance rate for the NFT asset based on the market price, and transmitting, via the policy monitoring tool, the insurance rate to a GUI of a computing device of the user.

1. A system for non-fungible token (NFT) asset protection, the system comprising:
a policy monitoring tool comprising a hack attempt model, a claim validation model, and a market price setting model;
one or more processors;
one or more memory components communicatively coupled to the one or more processors and the policy monitoring tool; and
machine readable instructions stored in the one or more memory components that cause the system to perform at least the following when executed by the one or more processors:
predict, via the hack attempt model, a prediction that a hack attempt of an NFT asset of a user of the policy monitoring tool has occurred;
upon receiving the prediction that the hack attempt has occurred, receive an insurance claim for processing;
validate, via a claim validation model, the insurance claim;
determine, via the market price setting model, a market price for the NFT asset in real-time based on one or more monitored NFT marketplaces;
set an insurance rate for the NFT asset based on the market price; and
transmit, via the policy monitoring tool, the insurance rate to a graphical user interface (GUI) of a computing device of the user.

2. The system of claim 1, further comprising machine readable instructions that cause the system to perform at least the following when executed by the one or more processors:
monitor the NFT asset of the user of the policy monitoring tool, wherein the user has registered the NFT asset with the policy monitoring tool, and the policy monitoring tool has stored a digital footprint of the user.

3. The system of claim 2, further comprising machine readable instructions that cause the system to perform at least the following when executed by the one or more processors:
set the insurance rate for the NFT asset based on the market price and the digital footprint of the user.

4. The system of claim 3, wherein the digital footprint of the user comprises usage data associated with the user based on user activities and a risk score based on the usage data, wherein when the risk score is below an acceptable risk threshold, the insurance rate is increased.

5. The system of claim 4, further comprising machine readable instructions that cause the system to perform at least the following when executed by the one or more processors:
determine, based on the usage data, that the user has conducted a risk activity comprising visiting one or more blacklisted websites, opening a malicious link, or combinations thereof; and
increase the risk score based on the risk activity.

6. The system of claim 2, further comprising machine readable instructions that cause the system to perform at least the following when executed by the one or more processors:
receive user credentials associated with the NFT asset of the user upon registration of the asset by the user.

7. The system of claim 6, further comprising machine readable instructions that cause the system to perform at least the following when executed by the one or more processors:
store the user credentials associated with the NFT asset in a private cloud storage, the private cloud storage communicatively coupled with the policy monitoring tool.

8. The system of claim 6, further comprising machine readable instructions that cause the system to perform at least the following when executed by the one or more processors:
access, via the policy monitoring tool and based on the user credentials, the NFT asset when the NET asset is stored in a public cloud storage based on receipt of input of at least one of access to the NFT asset being lost by the user or stolen.

9. The system of claim 1, further comprising machine readable instructions that cause the system to perform at least the following when executed by the one or more processors:
process a payout of the insurance claim based on the insurance rate to the user.

10. The system of claim 1, further comprising machine readable instructions that cause the system to perform at least the following when executed by the one or more processors:
receive a download notification that the user has downloaded the policy monitoring tool as an application on the computing device of the user;
receive a registration notification that the user has registered the NFT asset with the policy monitoring tool; and
issue an insurance policy for the NFT asset of the user based on the download notification and the registration notification.

11. The system of claim 1, further comprising machine readable instructions that cause the system to perform at least the following when executed by the one or more processors:
train the hack attempt model to predict that the hack attempt has occurred based on one or more patterns and risk factors associated with one or more historical hack attempts of one or more NFT assets, wherein the NFT asset of the user may be one of the one or more NFT assets.

12. The system of claim 11, further comprising machine readable instructions that cause the system to perform at least the following when executed by the one or more processors:
predict, via the hack attempt model, a likelihood of hack attempt occurring with respect to the NFT asset of the user based on the patterns and risk factors associated with the one or more historical hack attempts of the one or more NFT assets and a digital footprint of the user of the NFT asset, wherein the digital footprint of the user comprises usage data associated with the user based on user activities.

13. A system for non-fungible token (NFT) asset protection, the system comprising:
a policy monitoring tool comprising a hack attempt model, a claim validation model, and a market price setting model;
one or more processors;
one or more memory components communicatively coupled to the one or more processors and the policy monitoring tool; and
machine readable instructions stored in the one or more memory components that cause the system to perform at least the following when executed by the one or more processors:
monitor an NFT asset of the user of the policy monitoring tool, wherein the user has registered the asset with the policy monitoring tool, and the policy monitoring tool has stored a digital footprint of the user, wherein user credentials associated with the NFT asset are received upon registration of the asset by the user;
predict, via the hack attempt model, a prediction that a hack attempt of the NFT asset of the user of the policy monitoring tool has occurred;
upon receiving the prediction that the hack attempt has occurred, receive an insurance claim for processing;
validate, via a claim validation model, the insurance claim;
determine, via the market price setting model, a market price for the NFT asset in real-time based on one or more monitored NFT marketplaces;
set an insurance rate for the NET asset based on the market price and the digital footprint of the user;
transmit, via the policy monitoring tool, the insurance rate to a graphical user interface (GUI) of a computing device of the user; and
process a payout of the insurance claim based on the insurance rate to the user.

14. The system of claim 13, wherein the digital footprint of the user comprises usage data associated with the user based on user activities and a risk score based on the usage data, wherein when the risk score is below an acceptable risk threshold, the insurance rate is increased.

15. The system of claim 14, further comprising machine readable instructions that cause the system to perform at least the following when executed by the one or more processors:
determine, based on the usage data, that the user has conducted a risk activity comprising visiting one or more blacklisted website, opening a malicious link, or combinations thereof; and
decrease the risk score based on the risk activity.

16. The system of claim 13, further comprising machine readable instructions that cause the system to perform at least the following when executed by the one or more processors:
store the user credentials associated with the NFT asset in a private cloud storage, the private cloud storage communicatively coupled with the policy monitoring tool.

17. The system of claim 13, further comprising machine readable instructions that cause the system to perform at least the following when executed by the one or more processors:
access, via the policy monitoring tool and based on the user credentials, the NFT asset when the NFT is stored in public cloud storage based on receipt of input of at least one of access to the NFT asset being lost by the user or stolen.

18. The system of claim 13, further comprising machine readable instructions that cause the system to perform at least the following when executed by the one or more processors:
train the hack attempt to predict that the hack attempt has occurred based on one or more patterns and risk factors associated with one or more historical hack attempts of one or more NFT assets, wherein the NFT asset of the user may be one of the one or more NFT assets.

19. The system of claim 18, further comprising machine readable instructions that cause the system to perform at least the following when executed by the one or more processors:
predict, via the hack attempt model, a likelihood of hack attempt occurring with respect to the NFT asset of the user based on the patterns and risk factors associated with the one or more historical hack attempts of the one or more NFT assets and the digital footprint of the user of the NFT asset, wherein the digital footprint of the user comprises usage data associated with the user based on user activities.

20. A method for non-fungible token (NFT) asset protection utilizing a policy monitoring tool, the method comprising:
predicting, via a hack attempt model of the policy monitoring tool, a prediction that a hack attempt of an NFT asset of a user of the policy monitoring tool has occurred;
upon receiving the prediction that the hack attempt has occurred, receiving an insurance claim for processing;
validating, via a claim validation model of the policy monitoring tool, the insurance claim;
determining, via a market price setting model of the policy monitoring tool, a market price for the NET asset in real-time based on one or more monitored NFT marketplaces;
setting an insurance rate for the NFT asset based on the market price; and
transmitting, via the policy monitoring tool, the insurance rate to a graphical user interface (GUI) of a computing device of the user.
